(19) United States
(12) Patent Application Publication
(10) Pub. No.: US 2013/0041890 A1
(43) Pub. Date: Feb. 14, 2013

(54) METHOD FOR DISPLAYING CANDIDATE IN CHARACTER INPUT, CHARACTER INPUTTING PROGRAM, AND CHARACTER INPUT APPARATUS

(71) Applicant: Takuya Nakayama, Kyoto (JP)

(72) Inventor: Takuya Nakayama, Kyoto (JP)

(73) Assignee: OMRON Corporation, Kyoto-Shi, Kyoto (JP)

(21) Appl. No.: 13/578,395

(22) PCT Filed: Jan. 19, 2011
(86) PCT No.: PCT/JP2011/050847

§ 371 Date: Oct. 19, 2012

(30) Foreign Application Priority Data
Jul. 13, 2010 (JP) 2010-158722

(51) Int. Cl. G06F 17/30

(52) U.S. Cl. 707/722; 707/E17.082

(57) ABSTRACT

A character input apparatus has a storage section in which a conversion dictionary and a learning dictionary are stored, wherein a plurality of pieces of dictionary data each of which includes a pre-conversion character string and a post-conversion character string are registered in the conversion dictionary, and the learning dictionary is used to register a phrase fixed as an input character string while the phrase is correlated with collocation relationship between phrases, a first candidate extracting section that searches the conversion dictionary using the pre-conversion character string in response to an input of the pre-conversion character string to extract and display a candidate of the post-conversion character string, and a second candidate extracting section that extracts and displays a phrase that collocates with the phrase indicated by the fixed character string from the learning dictionary as the input character string is fixed.

### TECHNICAL FIELD

The present invention relates to a candidate display method, which is performed by a computer including a function of displaying a candidate of a post-conversion character string according to an input of a pre-conversion character string and a function of displaying a character string that is possibly input next as the candidate as the input character string is fixed, when the computer performs character input processing to an operating application using the functions. The present invention also relates to a program to which the display method is applied and a character input apparatus.

### BACKGROUND ART

In order to eliminate inconvenience of operability, two kinds of candidate extracting functions are set in a device, such as a mobile phone, in which the number of keys used to input a character is restricted. One of the candidate extracting functions is a function of displaying a phrase having reading, which matches a reading character string constructed by a character input manipulation on a left-hand side, as the candidate every time the character input manipulation is performed. The other candidate extracting function is a function of predicting and displaying the character string that is possibly input next based on a past input history at the time one of the displayed candidates is fixed by a selection manipulation. Hereinafter, processing by the function of the former is referred to as “predictive conversion processing”, and the candidate extracted through the predictive conversion processing is referred to as a “conversion candidate”. Processing by the function of the latter is referred to as “collocation predictive processing”, and the candidate extracted through the collocation predictive processing is referred to as a “collocation predictive candidate”.

For example, Patent Document 1 discloses an information processing apparatus that performs the predictive conversion processing and the collocation predictive processing (see paragraph 0017 and FIG. 1).

Patent Document 2 discloses a technology, in which the conversion candidate suitable for an input situation is preferentially displayed compared with other candidates when the conversion candidates extracted through the predictive conversion processing are displayed. Specifically, in the description of Patent Document 2, a word in which an attribute relating to the input situation is set is registered in a conversion dictionary, the input situation during character input is determined, and a priority order of the conversion candidate in which the attribute applied to a determination result of the input situation is set is adjusted to display the conversion candidate in a high order. According to the predictive conversion processing disclosed in Patent Document 2, even if the identical pre-conversion character string is input, a display order of each conversion candidate can be varied according to the input situation. For example, in the description of paragraphs 0044 to 0049 and FIG. 4 of Patent Document 2, the display order of the conversion candidate is varied by registering the word to which attribute data expressing a season is set, in the case that the identical reading character string is input in spring or autumn.

### PATENT DOCUMENTS

Patent Document 1: Japanese Unexamined Patent Publication No. 2005-173984
Patent Document 2: Japanese Unexamined Patent Publication No. 2009-276818

### SUMMARY

In the conventional conversion candidate or collocation predictive candidate, generally the conversion candidate or the collocation predictive candidate, which is selected in recent days or frequently selected, is preferentially displayed. However, possibly the preferential display is continued even if necessity of the preferential display is eliminated. For example, in the case that persons frequently contact each other by mail in a given period during and before and after an event performed on a specific day, the word expressing the event is preferentially displayed to improve usability. However, the usability is degraded, when the preferential display is continued even if the necessity of the contact is eliminated.

According to the technology disclosed in Patent Document 2, the display order can be changed according to an input day for the word that is previously registered as the word suitable for the input day. However, the display order of the candidate is hardly adjusted for a conversation subject that is freely expressed by a user.

One or more embodiments of the present invention displays, in the case that the user talks about a predetermined date and time to create a document, the phrase, which was learned when the user talked about the similar date and time to create the document in the past, as the high-order candidate.

One or more embodiments of the present invention is applied to a computer including storage means in which a conversion dictionary and a learning dictionary are stored, a plurality of pieces of dictionary data each of which includes a pre-conversion character string and a post-conversion character string being registered in the conversion dictionary, the learning dictionary being used to register a phrase fixed as an input character string while the phrase is correlated with collocation relationship between phrases, the computer performing character input processing in which the dictionaries are used. The character input processing includes a first candidate extracting step (corresponding to predictive conversion processing), a second candidate extracting step (corresponding to collocation predictive processing), and a candidate fixing step, the conversion dictionary being searched using the pre-conversion character string in response to an input of the pre-conversion character string to extract and display a candidate of the post-conversion character string in the first candidate extracting step, a phrase that collocates with the phrase indicated by the fixed character string being extracted from the learning dictionary and displayed as the input character string is fixed in the second candidate extracting step, the phrase of the selected candidate being fixed as one of the candidates displayed in one of the first and second candidate extracting steps is selected in the candidate fixing step.

As used herein, the “phrase” means an overall character string (a character string expressing a freely-set “word”) that is fixed according to a user manipulation. That is, both the character string including the plural words and the character string including only the single word are the phrase, and a character and a character string that express an attached word, such as an ending and a particle, are also the phrase.

Additionally, in one or more embodiments of the present invention, the computer performs a date and time estimation step and a registration step, a date and time being estimated according to a fixed situation of a phrase expressing the date and time and date and time data indicating an estimation result being set in the date and time estimation step, the phrase fixed in the candidate fixing step being registered in the learning dictionary while correlated with the date and time data in the registration step. In the second candidate extracting step, the computer preferentially displays a candidate that is registered in the learning dictionary while correlated with date and time data, which is applied to date and time data at a time a preceding phrase is fixed, in candidates extracted from the learning dictionary, compared with other candidates.

According to the method, for example, when a phrase expressing date and time is fixed in creating a document A relating to a certain case, date and time data is set according to the concept of the fixed phrase, the phrase expressing the date and time and a phrase collocating with the phrase are registered in the learning dictionary while correlated with the date and time data. After that, in the case that the user creates a document B relating to the same case as the document A, when the same date and time data as that in the creation of the document A is set according to the fixed situation of the phrase expressing the date and time, the candidate input to the document A in the extracted candidates can preferentially be displayed compared with other candidates in performing the second candidate extracting step.

Therefore, even if the date and time of the same case as the document A is expressed by the phrase different from that of the document A because the day of the document input is changed, the collocation predictive candidate can preferentially be displayed compared with other candidates based on the collocation relationship of the phrase that was learned in creating the document A. Accordingly, the phrase that is probably selected by the user can be displayed in the high order of the candidate display list.

In one or more embodiments of the present invention, the date and time estimation step includes: a step of initially setting the date and time data to data indicating a current date and time in response to starting of the character input processing; and a step of updating the date and time data based on a concept of the date and time expressed by the fixed phrase as the phrase expressing the date and time is fixed. According to one or more embodiments of the present invention, even if the creation of the document is started in the date and time corresponding to the date and time talked about in the document A created in the past, the phrase input to the document A can be displayed in the high order of a list of the collocation predictive candidates. In the case that the document relating to the date and time different from the current date and time is created, as the phrase expressing the date and time is fixed, the date and time data can quickly be updated to a content applied to the conversation subject.

In one or more embodiments of the present invention, when the phrase expressing the date and time is fixed in the candidate fixing step, in the second candidate extracting step, a first search and a second search are performed using the date and time data that is set in the date and time estimation step according to the fixed phrase, the first search specifying a phrase, which corresponds to date and time data applied to the date and time data and expresses the date and time, the second search extracting a phrase that is registered in the learning dictionary while collocating with the phrase specified by the first search, and the phrase extracted through the second search is included in the preferentially-displayed candidate.

According to one or more embodiments of the present invention, even if the phrase different from that of the document A is input as the phrase expressing the date and time in creating the document relating to the same case as the document A created in the past, the phrase that is input in fixing the phrase while collocating with the phase expressing the date and time in creating the document A can be displayed in the high order of the candidate display list.

In one or more embodiments of the present invention, when document data received from an outside is analyzed to extract a phrase expressing a date and time, date and time data suitable for a concept of the phrase is set, and the set date and time data is registered in the learning dictionary while correlated with the phrase expressing the date and time and each phrase collocating with the phrase expressing the date and time. Therefore, for example, in the case that a reply mail to the received mail is created, even if the date and time is expressed by the phrase different from that of the received document, the phrase included in the received mail can be displayed in the high order as the collocation predictive candidate.

In one or more embodiments of the present invention, also in the first candidate extracting step, the candidate that is registered in the learning dictionary while correlated with the date and time data applied to the date and time data set in the date and time estimation step is specified from the candidates, which are extracted from the conversion dictionary using the input pre-conversion character string, and the specified candidate can preferentially be displayed compared with other candidates. Therefore, even if the conversion candidate extracted by a predictive conversion function is displayed, the phrase that is learned through the character input processing, which is performed while the date and time similar to that of the currently-input document is talked about, can be displayed in the high order.

A program according to one or more embodiments of the present invention causes a computer to act as a character input apparatus, the character input apparatus including: storage means in which a conversion dictionary and a learning dictionary are stored, a plurality of pieces of dictionary data each of which includes a pre-conversion character string and a post-conversion character string being registered in the conversion dictionary, the learning dictionary being used to register a phrase fixed as an input character string while the phrase is correlated with collocation relationship between phrases; first candidate extracting means for searching the conversion dictionary using the pre-conversion character string in response to an input of the pre-conversion character string to extract and display a candidate of the post-conversion character string; second candidate extracting means for extracting and displaying a phrase that collocates with the phrase indicated by the fixed character string from the learning dictionary as the input character string is fixed; candidate fixing means for fixing the phrase of the selected candidate as one of the candidates displayed by one of the first and second candidate extracting means is selected; and registration processing means for registering the phrase fixed by the candidate fixing means in the learning dictionary.

The program further includes a program that causes the computer to act as date and time estimation means for estimating a date and time according to a fixed situation of a phrase expressing the date and time, and setting date and time data indicating an estimation result. The registration processing means registers the phrase fixed in the candidate fixing step in the learning dictionary while correlating the phrase with the date and time data. The second candidate extracting means preferentially displays a candidate that is registered in the learning dictionary while correlated with date and time data, which is applied to date and time data at a time a preceding phrase is fixed, in candidates extracted from the learning dictionary, compared with other candidates.

In one or more embodiments of the program, the date and time estimation means initially sets the date and time data to data indicating a current date and time in response to start-up of the document input device, and then as a phrase expressing a date and time is fixed by the candidate fixing means, the date and time estimation means updates the date and time data based on a concept of the date and time expressed by the fixed phrase.

In one or more embodiments of the present invention, when processing is performed as the phrase expressing the date and time is fixed, the second candidate extracting means performs a first search and a second search using the date and time data that is set according to the fixed phrase by the date and time estimation means, the first search specifying a phrase, which corresponds to date and time data applied to the date and time data and expresses the date and time, the second search extracting a phrase that is registered in the learning dictionary while collocating with the phrase specified by the first search, and the second candidate extracting means includes the phrase extracted through the second search in the preferentially-displayed phrase.

In one or more embodiments of the present invention, the first candidate extracting means specifies the candidate, which is registered in the learning dictionary while correlated with the date and time data set by the date and time estimation means, from the candidates, which are extracted from the conversion dictionary using the input pre-conversion character string, and the first candidate extracting means preferentially displays the specified candidate compared with other candidates.

For example, the program can be installed in a computer that is incorporated as a controller into a mobile terminal, such as a mobile phone and a PDA. The program can also be installed in a personal computer. The computer in which the program is installed operates as a character input apparatus, the character input apparatus including storage means in which a conversion dictionary and a learning dictionary are stored, first candidate extracting means, second candidate extracting means, candidate fixing means, registration processing means, and date and time estimation means. According to the character input apparatus, the phrase that is learned through the character input processing, which is performed while the date and time similar to that of the currently creating document is talked about, can be displayed in the high order of the candidate display list.

According to one or more embodiments of the present invention, the phrase, which was learned through the character input processing performed in the past for the case relating to the date and time talked about in the current character input processing, can be displayed in the high order of the candidate display list. Therefore, in the case that the user freely talks about the predetermined date and time to create the document, the phrase, which was learned when the user talked about the similar date and time to create the document in the past, can be displayed in the high order of the candidate display list. Accordingly, the candidate that is probably selected by the user can be displayed in the high order to largely enhance the usability of character input processing.

### BRIEF DESCRIPTION OF THE DRAWINGS

FIG. 1 is a functional block diagram of a character input system.

FIG. 2 is a view illustrating a data configuration example of a date and time corresponding table in FIG. 1.

FIG. 3 is a flowchart illustrating a schematic sequence of character input processing.

FIG. 4 is a flowchart illustrating a detailed sequence of conversation subject date and time estimation processing (step S9 in FIG. 3).

FIG. 5 is a view illustrating a specific example of unification processing.

FIG. 6 is a view illustrating a registration example for a learning dictionary and a relationship between registration data of the learning dictionary and a candidate extracted through collocation predictive processing.

FIG. 7 is a view illustrating a relationship between the candidate extracted through the collocation predictive processing and the registration data of the learning dictionary.

FIG. 8 is a view illustrating a relationship between the candidate extracted through predictive conversion processing and the registration data of the learning dictionary.

FIG. 9 is a view illustrating a relationship between the candidate extracted through the collocation predictive processing and the registration data of the learning dictionary.

FIG. 10 is a flowchart illustrating a detailed sequence of the collocation predictive processing (step S11 in FIG. 3).

FIG. 11 is a flowchart illustrating a detailed sequence of the predictive conversion processing (step S5 in FIG. 3).

### DETAILED DESCRIPTION

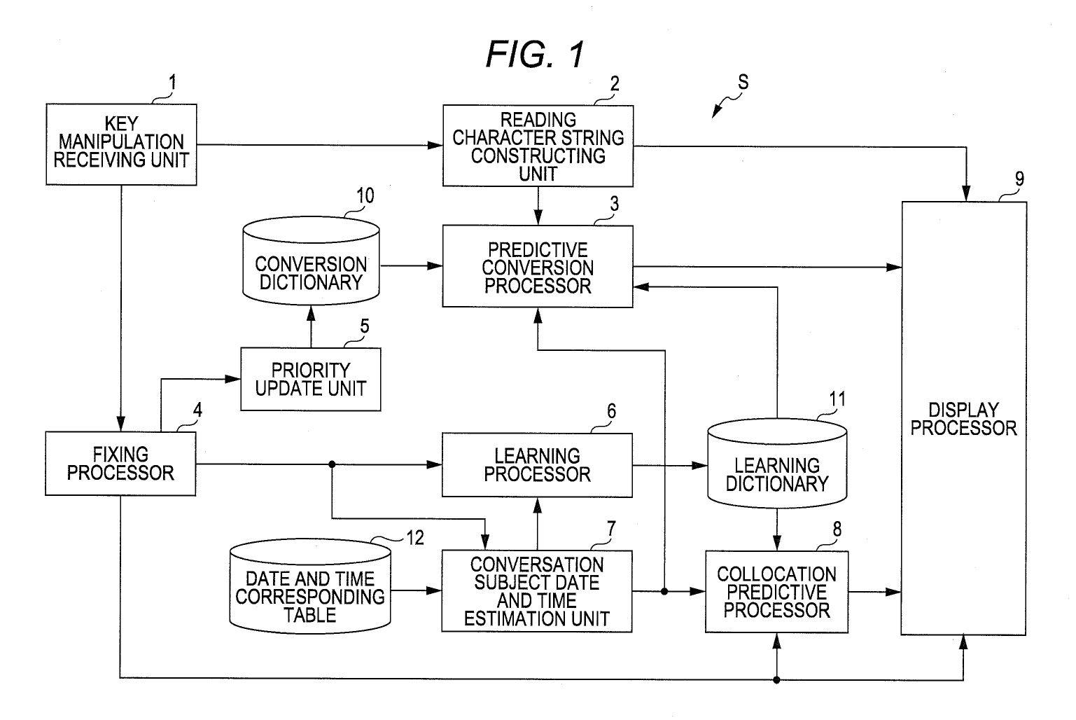

Embodiments of the present invention will be described below with reference to the drawings. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention. FIG. 1 is a functional block diagram of a character input system to which one or more embodiments of the present invention is applied. A character input system S is incorporated in a controller (computer) of a mobile terminal, such as a mobile phone, and used to input a Japanese character string to a high-order application (such as a mailer for transmitting and receiving an electronic mail). In FIG. 1, a conversion dictionary 10, a learning dictionary 11, and a date and time corresponding table 12 are stored in a memory (not illustrated) of the mobile terminal. Substances of a key manipulation receiving unit 1, a reading character string constructing unit 2, a predictive conversion processor 3, a fixing processor 4, a priority update unit 5, a learning processor 6, a conversation subject date and time estimation unit 7, a collocation predictive processor 8, and a display processor 9 are a CPU (not illustrated) that executes each processing program.

A dictionary data is stored in the conversion dictionary 10, and includes a character string (post-conversion character string) expressing each of plural phrases, a kana character string (pre-conversion character string) expressing reading, and a priority based on a past use history. The phrase, which is fixed by the character input system S and input to the high-order application, is stored in the learning dictionary 11.

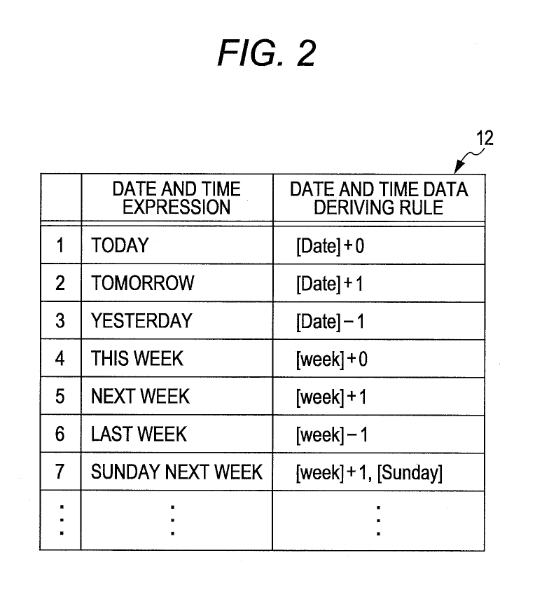

The date and time corresponding table 12 is used to replace the phrase expressing the date and time with a stylized date and time data. As illustrated in FIG. 2, plural combinations each of which includes the phrase expressing the date and time and a rule for deriving date and time data are registered in the date and time corresponding table 12.

In the date and time corresponding table 12 in FIG. 2, [Date] is a variable expressing a date of today, and [Week] is a variable expressing each of dates of seven days included in this week. As illustrated in 1 to 3 of the table 12, a rule to add or subtract an adjustment value expressing the number of days to or from [Date] is set to an expression expressing the date and time in units of days based on a relationship relative to today. As illustrated in 4 to 6 of the table 12, a rule to add or subtract an adjustment value expressing the number of weeks to or from [Week] is set to an expression expressing the date and time in units of weeks based on a relationship relative to this week.

A rule in which the rules corresponding to the date and time expressions are combined corresponds to the expression in which plural date and time expressions are combined like the seventh “Sunday next week”. However, this kind of rule is used only when the plural combinations of the date and time expressions are collectively fixed. Although described in detail later, when each expression is fixed one by one, a range of the date and time is narrowed every time the expression is fixed using the rule suitable for the fixed phrase.

Although not illustrated in FIG. 2, a rule to replace the expression, such as “Month Day”, which specifically expresses the date and time, with the stylized date and time data is also set to the date and time corresponding table 12.

In the character input system S of one or more embodiments of the present invention, the date and time suitable for the conversation subject in the currently-input document is estimated using the date and time corresponding table 12, and reflects an estimation result in the display of the predictive conversion candidate or the collocation predictive candidate. The conversation subject date and time estimation unit 7 in FIG. 1 performs the date and time estimation processing to create the date and time data expressing the estimation result. Hereinafter the date and time data expressing the estimation result is referred to as “conversation subject date and time data”.

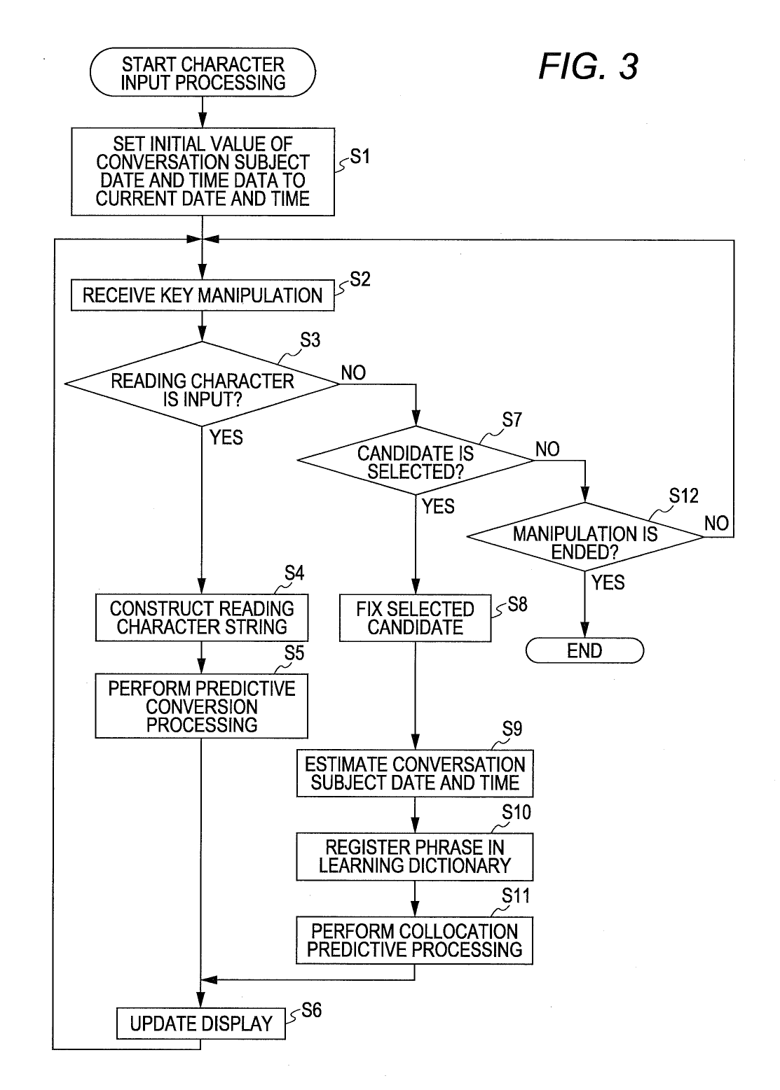

Processing performed by each function of the character input system S will be described below with reference to FIG. 3.

The character input processing system S is started up together with the high-order application, and the conversation subject date and time estimation unit 7 performs the processing of setting the current date and time to an initial value of the conversation subject date and time data (step S1).

Then, the character input processing system S becomes a state in which a key manipulation of a manipulation unit (not illustrated) is received, and the key manipulation receiving unit 1 receives the manipulation every time the manipulation is performed to determine the manipulated key (step S2). When the key manipulation receiving unit 1 determines that the character inputting key manipulation is performed (“YES” in step S3), the flow goes to the processing of the reading character string constructing unit 2 to construct a reading character string according to the key manipulation (step S4).

According to the construction of the reading character string, the predictive conversion processor 3 searches the conversion dictionary 10 using the reading character string to extract a predetermined number of conversion candidates (step S5). The display processor 9 updates screen display of a display unit, not illustrated, using the reading character string constructed by the reading character string constructing unit 2 or the conversion candidate extracted by the predictive conversion processor 3 (step S6). Steps S2 to S6 are performed every time the reading character string is input, thereby updating the displays of the reading character string and the conversion candidate. When the user performs the manipulation to select one of the conversion candidates during the display update at a predetermined time, the determination in step S7 becomes affirmative to perform steps S8 to S11.

In step S8, the fixing processor 4 performs the processing of outputting the character string of the selected candidate to the high-order application. Hereinafter the character string output to the high-order application is referred to as a “fixed phrase”. The processing in step S8 includes processing (processing performed by priority update unit 5) of adding a given frequency to a priority order of dictionary data corresponding to the fixed phrase in the conversion dictionary 10.

In step S9, the conversation subject date and time estimation processor 7 performs the estimation processing. In step S10, the learning processor 6 performs the processing of registering the fixed phrase in the learning dictionary 11. Although described in detail later, in one or more embodiments of the present invention, a combination of the fixed phrase and the current conversation subject date and time data is accumulated in the learning dictionary 11 in the time-series order, whereby the fixed phrase is retained every time the fixed phrase is correlated with collocation relationship between phrases.

In step S11, the collocation predictive processor 8 performs the processing of extracting the collocation predictive candidate corresponding to the fixed phrase from the learning dictionary 11.

After steps S8 to S11, the flow goes to the display update processing in step S6. In the display update processing, the reading character string in the input screen is replaced with the fixed phrase, a display field of the candidate is updated to the display of the collocation predictive candidate. When one of the collocation predictive candidates is selected on the screen, steps S8 to S11 are performed again, and the flow goes to step S6. Therefore, the display of the fixed phrase or the collocation predictive candidate is updated.

Although not illustrated in FIG. 3, when a manipulation to issue an instruction to fix the reading character string or a manipulation to issues an instruction to convert the reading character string into a numerical character or an alphabet is received, steps S8 to S11 and step S6 are performed after the phrase is fixed in response to the instruction. When the key manipulation receiving unit 1 receives an ending instruction manipulation at a predetermined time point, the determination in step S12 becomes affirmative to end the character input processing.

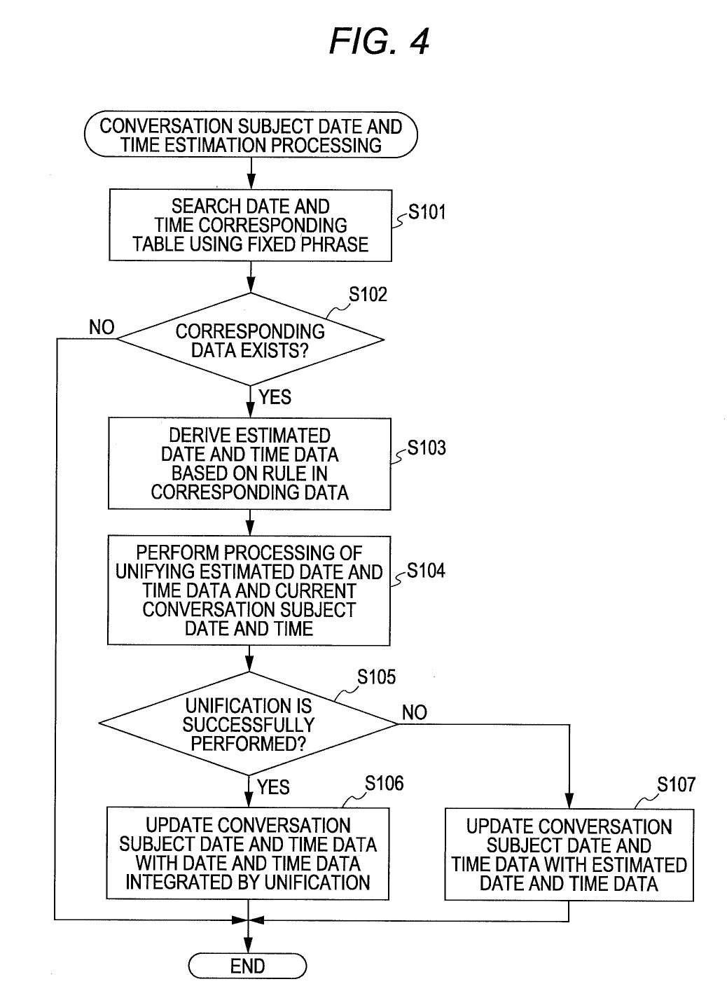

As illustrated in FIG. 3, in one or more embodiments of the present invention, the conversation subject date and time data is initially set to the data indicating the current date and time at the beginning of the character input processing, and the conversation subject date and time data can be updated according to the content of the currently creating document through the processing of estimating the conversation subject date and time in step S9 (step S9). A detailed sequence of the conversation subject date and time estimation processing will be described with reference to FIG. 4.

In step S101, “date and time expression” of the date and time corresponding table 12 is searched using the preceding fixed phrase. When the date and time expression corresponding to the fixed phrase cannot be found through the search, the determination in step S102 becomes negative, and the processing is ended without updating the conversation subject date and time data.

On the other hand, when the date and time expression corresponding to the fixed phrase is found, the determination in step S102 becomes affirmative to perform pieces of processing from step S103. In step S103, the date and time data suitable for the fixed phrase is derived based on the rule corresponding to the date and time expression found through the search. Hereinafter the date and time data derived at this stage is referred to as “estimated date and time data”.

Processing of unifying the estimated date and time data and current conversation subject date and time data is performed in step S104. The unification processing means processing in which two kinds of the pieces of date and time data are integrated by an overlapping portion between both sides.

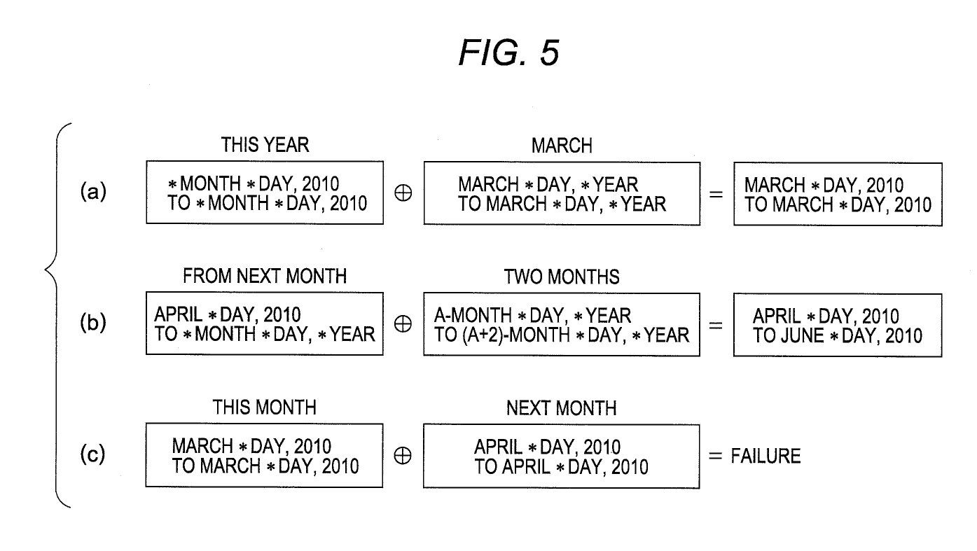

FIG. 5 illustrates a specific example of the unification processing. In FIG. 5, an arbitrary numerical value in a numerical range applied to a concept of the corresponding data is set to * in the date and time data. For example, the numerical value in the range of 1 to 12 is set to “* month”, and the numerical value in the range of 1 to 31 is set to “* day” (depending on the month, occasionally the numerical value becomes the range of 1 to 30 or 1 to 28). In an example (b), the numerical value (in the example, 4) set to the date and time data of the other party of the unification is substituted for A in the date and time data.

Referring to FIG. 4, the description is continued. As illustrated in examples (a) and (b) in FIG. 5, the overlapping is recognized between the pieces of processing target date and time data, and the pieces of date and time data are integrated to the overlapping portion. In this case, the determination in step S105 becomes affirmative, and the conversation subject date and time data is updated by the date and time data integrated by the unification (step S106). On the other hand, as illustrated in an example (c) in FIG. 5, the integration cannot be performed because the overlapping portion does not exist between the pieces of date and time data. In this case, the determination in step S105 becomes negative to discard the current conversation subject date and time data, and the estimated date and time data derived in step S103 is set to the new conversation subject date and time data (step S107).

According to the above sequence, the conversation subject date and time data is set to the data expressing the current date and time at the beginning of the character input processing. When the phrase (such as “tomorrow” and “yesterday”) expressing the date and time different from the current date and time is fixed to drive estimated date and time data corresponding to the phrase, the conversation subject date and time data is updated by the estimated date and time data. The conversation subject date and time data suitable for the conversation subject of the currently creating document is set by the update.

In the case that the phrase expressing the date and time is fixed plural times in one document, the sequence in FIG. 4 is performed every time. Accordingly, for the expression, such as “next week/of/Sunday”, in which the date and time is restricted by the plural phrases, step S107 is performed according to the fixing of “next week”, step S106 is performed according to the fixing of “Sunday”, which allows the conversation subject date and time data to be narrows into a proper range. When the date and time expression, such as “this week/is/ . . . , next week/is/ . . . ”, in which the unification cannot be performed in one document, is fixed plural times, because step S107 is performed in both the cases that “this week” and “next week” are fixed, the conversation subject date and time data is updated to the content suitable for the concept of the fixed phrase every fixing time. Thus, the conversation subject date and time data having the content suitable for the concept of the fixed phrase can be set according to the fixed phrase expressing the date and time.

The conversation subject date and time data is used in the registration processing (step S10 in FIG. 3) for the learning dictionary 11 and the candidate extracting processing (steps S5 and S11 in FIG. 3). These pieces of processing will be described using specific example.

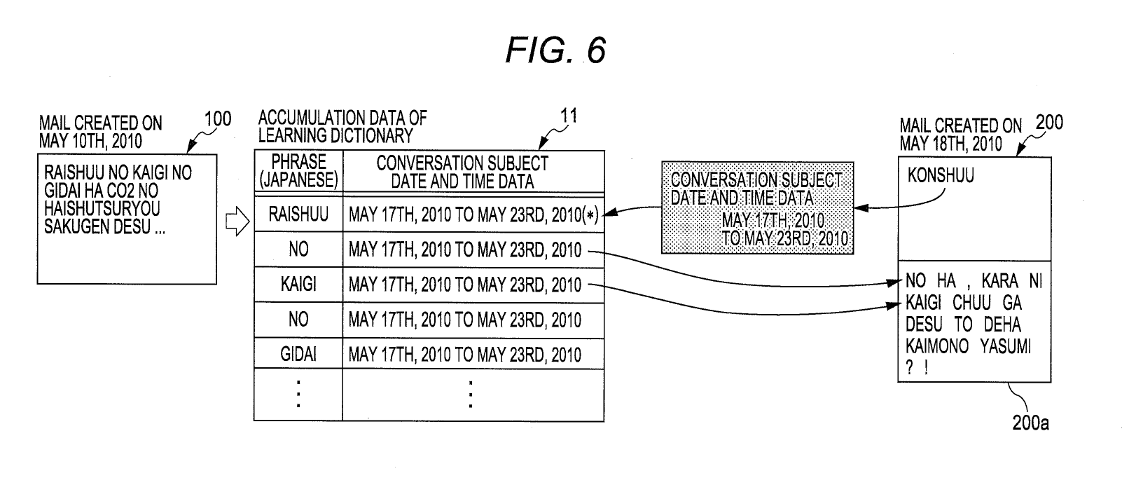

FIG. 6 illustrates an example, in which the phrase in a mail document 100 is registered in the learning dictionary 11 as the mail document 100 including the date and time expression is created, and the registration data is called at a later date as the collocation predictive candidate when another mail is created.

In one or more embodiments of the present invention, every time the phrase input to the high-order application is fixed, the fixed phrase is registered in the learning dictionary 11 while combined with the conversation subject date and time data at the time the phrase is fixed.

In the example in FIG. 6, when the mail document 100 is created on May 10, 2010, at first step S107 is performed in the conversation subject date and time estimation processing performed by fixing the phrase of “raishuu” expressing the date and time, and the conversation subject date and time data of “May 17, 2010 to May 23, 2010” is set. Therefore, “raishuu” and subsequent fixed phrases (no/kaigi/no/gidai . . . ) are registered in the learning dictionary 11 combined with the conversation subject date and time data. A flag (indicated by a symbol * in FIG. 6, hereinafter the flag is referred to as a “keyword flag”) indicating that the phrase is a keyword relating to the date and time expression is set to the fixed phrase of “raishuu” expressing the date and time.

The symbol 200 on the right in FIG. 6 designates a mail creating screen that is created on May 18, 2010 eight days after the creation of the mail document 100, and the mail creating screen 200 illustrates the state at the time point in which the phrase of “konshuu” is fixed. As the phrase of “konshuu” is fixed, the plural collocation predictive candidates are displayed in a candidate display field 200a of the screen 200.

In the mail creating processing on the screen 200, the conversation subject date data having the content of “May 17, 2010 to May 23, 2010” is set through the conversation subject date and time estimation processing, which is performed as the phrase of “konshuu” expressing the date and time is fixed. Although not illustrated, the conversation subject date and time data is also registered in the learning dictionary 11 while combined with “konshuu” and the later-fixed phrase.

In the collocation predictive processing of one or more embodiments of the present invention, like the conventional technology, for the phrase of the fixed candidate, the phrase that is registered in the learning dictionary 11 while collocating with the fixed phrase in the past is extracted, and the extracted phrase is set to the collocation predictive candidate. When the phrase expressing the date and time is fixed as illustrated in the example in FIG. 6, the learning dictionary 11 is searched using the conversation subject date and time data (data updated in step S106 or S107) that is updated through the conversation subject date and time estimation processing, which is performed as the phrase expressing the date and time is fixed, and the keyword (the phrase to which the keyword flag is set) combined with the conversation subject date and time data applied to a search condition is extracted. The phrase that is combined with the same conversation subject date and time data as the keyword while collocating with the keyword is extracted as the collocation predictive candidate.

A priority order is set to the collocation predictive candidate extracted through each search according to intensity of the collocation with the fixed phrase or the keyword. A predetermined increment is added to the priority order of the candidate that is combined with the conversation subject date and time data applied to the current setting. Therefore, the priority order of the phrase, which is input to past document relating to the case applied to the current conversation subject date and time data, is enhanced.

In the document input processing on the screen 200 in FIG. 6, “raishuu” registered in creating the mail document 100 is extracted as the keyword applied to the conversation subject date and time data (May 17, 2010 to May 23, 2010), which is updated as the phrase of “konshuu” is fixed, through the search in which the conversation subject date and time data is used. Therefore, each phrase that is combined with the same conversation subject date and time data as “raishuu” while collocating with the “raishuu” is extracted as the collocation predictive candidate. As a result, “no” and “kaigi”, which are close to “raishuu” in the learning dictionary 11, are displayed in the high order of the candidate display field 200a of the screen 200 in the example in FIG. 6.

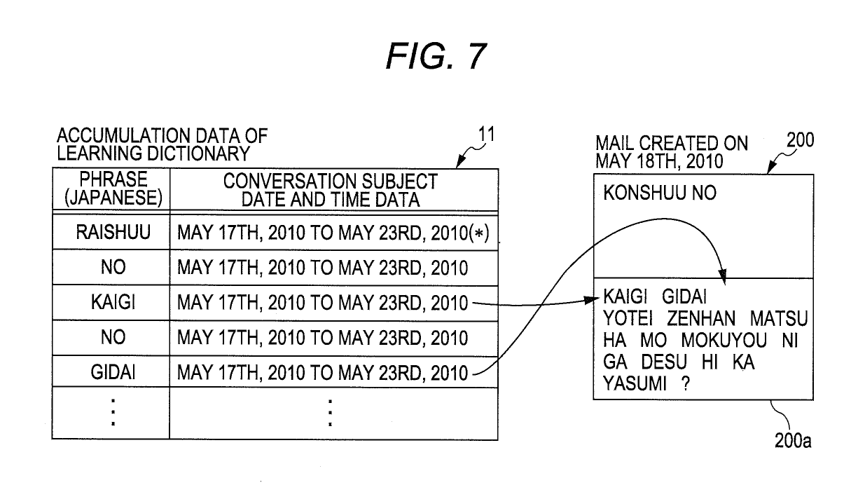

FIG. 7 illustrates the post-update screen 200 in the case that “no” in the collocation predictive candidates displayed in the candidate display field 200a in FIG. 6 is fixed together with a relationship between the post-update collocation predictive candidate and the dictionary data in the learning dictionary 11. Because the current fixed phrase “no” does not express the date and time, the conversation subject date and time data is not updated, but only the search to extract the phrase collocating with the fixed phrase “no” is performed in the collocation predictive processing. However, in the extracted collocation predictive candidates, because the priority order incrementing processing is performed to the candidate combined with the conversation subject date and time data applied to the current setting, the candidate to which the priority order incrementing processing is performed is easily displayed in the high order. As a result, in the example in FIG. 7, “kaigi” and “gidai”, which are combined with the conversation subject date and time data applied to the current setting, are displayed in the first order and the second order.

In the conventional collocation predictive processing, only the candidate is extracted based on the past input history. Therefore, even for the mail relating to the same conversation subject as the document created in the past, the phrase that was learned in creating the previous document is hardly displayed as the high-order candidate when the date and time is expressed by the phrase different from that of the previous document. On the other hand, in one or more embodiments of the present invention, as illustrated in FIGS. 6 and 7, the phrase that is registered in the learning dictionary while collocating with the date and time expression applied to the conversation subject date and time data is extracted using the conversation subject date and time data that is updated as the phrase expressing the date and time is fixed, and the priority order incrementing processing is performed to the extracted phrase. Therefore, the phrase that was learned in creating the mail talked about the date and time similar to that of the currently creating mail can be displayed in the high order of the list of the collocation predictive candidates. Therefore, the phrase that is probably selected by the user can be displayed as the high-order candidate to enhance the usability.

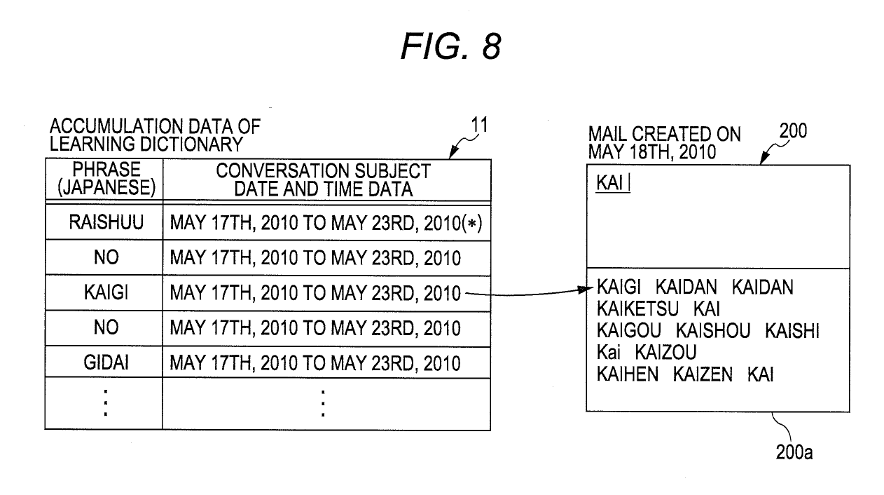

In one or more embodiments of the present invention, in the predictive conversion processing (step S5 in FIG. 3), similarly the priority order incrementing processing is performed to the candidate that is registered in the learning dictionary 11 while combined with the conversation subject date and time data applied to the current conversation subject date and time data in the extracted conversion candidates. FIG. 8 illustrates a display example of the conversion candidates after the priority order incrementing processing.

In the example in FIG. 8, it is assumed that the data having the same content as the examples in FIGS. 6 and 7 is registered in the learning dictionary 11. In the example in FIG. 8, the input character string is not fixed yet, but the reading character string of “kai” is input in unfixed state. Through the processing performed by the predictive conversion processor, plural phrases that match “kai” on the left side are displayed as the conversion candidate in the candidate display field 200a.

In the case that the phrase expressing the date and time is unfixed like the example in FIG. 8, conversation subject date and time data is set to May 18, 2010 of the current date and time. In this case, in the conversion candidates extracted by inputting the reading character string of “kai”, the priority order of the candidate that is registered in the learning dictionary 11 while combined with the conversation subject date and time data applied to the current conversation subject date and time data is incremented. As a result, in the example in FIG. 8, “kaigi” that is registered in the learning dictionary 11 while combined with the conversation subject date and time data of “May 17, 2010 to May 23, 2010” is displayed as the head candidate in creating the mail 100.

Thus, because the priority order of the conversion candidate applied to the current conversation subject date and time data is also enhanced in the predictive conversion processing, the candidate that is probably selected by the user is easily displayed in the high order. When the head candidate of “kaigi” is fixed in the example in FIG. 8, the phrase that is registered in the learning dictionary 11 while collocating with “kaigi” through the collocation predictive processing is extracted as the collocation predictive candidate. Also in this case, based on the conversation subject date and time data indicating the current date and time, the priority orders of the phrases (such as “no” and “gidai”) registered in creating the mail 100 are also enhanced and displayed in the high order of the candidate display field 200a.

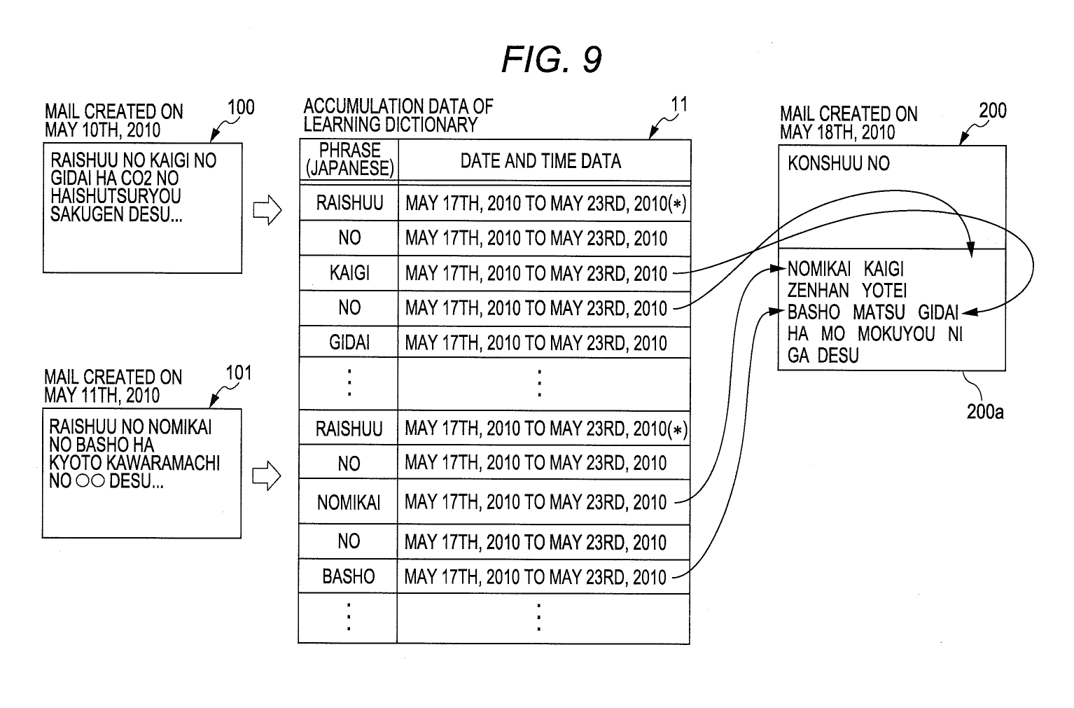

In an example in FIG. 9, it is assumed that a mail document 101 in which the date expression of “raishuu” is used is created again on the day following the day on which the mail document 100 in FIG. 6 is created. In creating the mail document 101, the processing similar to that of the case that “raishuu” is fixed in creating the mail document 100 is performed as the phrase of “raishuu” is fixed. As a result, each phrase that is fixed in creating the mail document 101 is registered in the learning dictionary 11 while combined with the conversation subject date data having the content of “May 17, 2010 to May 23, 2010”. The keyword flag is set to “raishuu” expressing the date and time.

Similarly to the examples in FIGS. 6 to 8, the displays at the time points in which the phrases of “konshuu” and “no” are sequentially fixed after the creation on May 18, 2010 are illustrated in the mail creating screen 200 in the example in FIG. 9.

In the example in FIG. 9, as the first phrase of “konshuu” is fixed, the content of the conversation subject date and time data is updated to “May 17, 2010 to May 23, 2010”. Accordingly, when “no” is fixed next time, similarly to the example in FIG. 7, in the candidates that are extracted in association with the various phrases of “no” registered in the learning dictionary 11, the priority order of the candidate combined with the conversation subject date and time data applied to the conversation subject date and time data is enhanced. As a result, “nomikai” and “basho” that are registered in the learning dictionary 11 in creating the mail document 101 and “kaigi” and “gidai” that are registered in the learning dictionary 11 in creating the mail document 101 are display in the high order of the candidate display field 200a of the example in FIG. 9.

Even if the plural cases applied to the conversation subject date and time data set through the currently-performed character input processing exist as illustrated in the example in FIG. 9, the phrase learned through the character input processing relating to each case can be displayed in the high order of the candidate display field 200a. Therefore, the character input processing aimed at any case can be dealt with to enhance the usability.

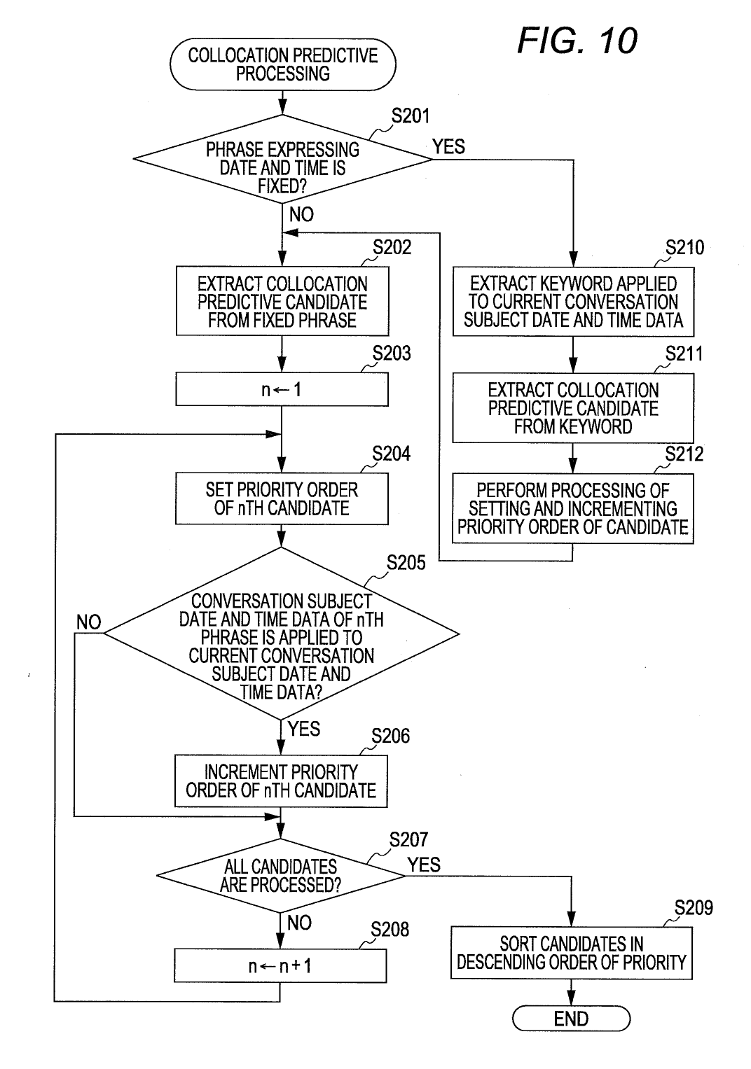

FIG. 10 illustrates a detailed sequence of the collocation predictive processing (corresponding to step S11 in FIG. 3). In the collocation predictive processing, at first the sequence (steps S202 to 209) commonly performed irrespective of a type of the fixed phrase will be described.

A search to extract the phrase collocating with the fixed phrase is performed in step S202. Specifically, the phrase that matches the fixed phrase is searched in the reverse chronological order of the pieces of data accumulated in the learning dictionary 11 until the number of phrases reaches a predetermined value. When the matched phrase is found through the search, a predetermined number of phrases subsequent to the found phrase are sequentially extracted from the phrase registered in the learning dictionary 11. The phrases are stored as the collocation predictive candidate in the candidate list of the work memory.

When the collocation predictive candidate is extracted through the above processing, a counter n is set to 1 in order to specify the candidate in step S203, and flow goes to a loop in steps S204 to 208. In the loop, the priority order of an nth candidate is set based on a degree of collocation with the fixed phrase (step S204). Specifically, the priority order of an nth candidate is set such that the priority order of the candidate that is stored in the learning dictionary 11 next to the same phrase as the fixed phrase becomes the highest, and such that the priority order is lowered as the storage position of the nth candidate is away from the same phrase as the fixed phrase.

Whether the conversation subject date and time data of the nth phrase is applied to the current conversation subject date and time data is determined (step S205). Specifically, the conversation subject date and time data of the nth candidate is read from the learning dictionary 11, and the unification processing of the read data and the current conversation subject date and time data is performed. When the unification is successfully performed, the determination that the conversation subject date and time data of the nth candidate is applied to the current conversation subject date and time data is made. When the unification is unsuccessfully performed, the determination that the conversation subject date and time data of the nth candidate is not applied to the current conversation subject date and time data is made.

When the determination is made that the conversation subject date and time data of the nth candidate is applied to the current conversation subject date and time data (“YES” in step S205), a predetermined increment value is added to the priority order of the candidate (step S206). Although the increment value may be kept constant, desirably the increment value is increased with increasing degree of the matching of the current conversation subject date and time data with the conversation subject date and time data combined with the nth candidate.

When the phrase expressing the date and time is fixed (“YES” in step S201), steps S210 to S212 are performed in advance of steps S202 to 208. In step 210, the keyword in which the conversation subject date and time data is applied to the current setting is searched in the reverse chronological order of the learning dictionary 11. Specifically, the phrase to which the keyword flag is set is extracted, and the unification processing of the conversation subject date and time data combined with the extracted phrase and the current conversation subject date and time data is performed to extract a successfully-unified phrase.

In step S211, the phrase that is registered in the learning dictionary 11 while collocating with the keyword extracted through the search is extracted, and stored in the list of the collocation predictive candidates. That is, the search processing similarly to that of the case that the collocation predictive candidate is extracted using the fixed phrase in step S202 is performed to the keyword extracted in step S210.

In step S212, the priority order is set to each candidate extracted in step S211 based on the degree of collocation with the keyword in the learning dictionary 11, and the predetermined increment value is added to the priority order. In this case, desirably the increment value is also increased with increasing degree of the matching of the current conversation subject date and time data with the conversation subject date and time data combined with the keyword.

Steps S202 to S208 are performed after steps S210 to S212 when the phrase expressing the date and time is fixed, and only the pieces of processing in steps S202 to S208 are performed when the phrase expressing the concept except the date and time is fixed. When the extraction of the collocation predictive candidate is completed, the candidates are sorted in the descending order of the priority (step S209), and the processing is ended. Then, because the display processor 9 performs the display update processing (step S6 in FIG. 3), the candidates are displayed in the order set in step S209.

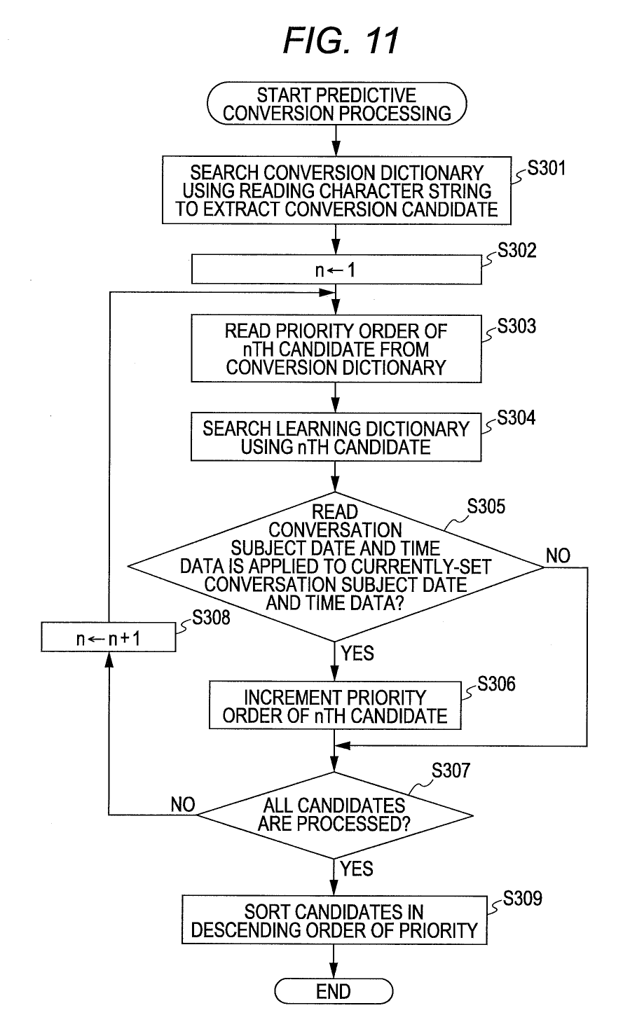

FIG. 11 illustrates a detailed sequence of the predictive conversion processing (step S5 in FIG. 3). In step S301 of the predictive conversion processing, the conversion dictionary 10 is searched using the reading character string constructed immediately before, and the phrase (post-conversion character string) that matches the reading character string on the left-hand side is extracted, and is set to the conversion candidate.

Then the processing is sequentially performed to the focused candidate using the counter n (steps S303 to S308). Specifically, the priority order of the nth candidate is read from the conversion dictionary 10 (step S303). Then, the learning dictionary 11 is searched using the nth candidate to read the conversation subject date and time data combined with the phrase corresponding to the candidate (step S304). Whether the read conversation subject date and time data is applied to the currently-set conversation subject date and time data is determined, in other words, whether the pieces of conversation subject date and time data can be unified is determined (step S305). When the plural phrases corresponding to the nth candidate are found through the search, the phrase having the highest degree of the matching with the current conversation subject date and time data is used to perform step S305. When the phrase corresponding to the nth candidate is not found, the determination in step S305 becomes negative.

When the pieces of conversation subject date and time data can be unified (“YES” in ST305), the predetermined increment value is added to the priority order read in step S303 (ST306). Also in this case, desirably the increment value is also increased with increasing degree of the matching of the current conversation subject date and time data with the conversation subject date and time data of the nth candidate. The incremented priority order is not reflected in the conversion dictionary 10, but cleared after the processing.

When the pieces of conversation subject date and time data cannot be unified, the determination in ST305 becomes negative to skip the priority order incrementing processing.

When the above processing is performed to all the candidates, the flow goes to step S309, and the candidates are sorted in the descending order of the priority. At this point, the candidate to which the incrementing processing is performed in step S306 is sorted in the incremented priority order. After the sort, through the display update processing (step S6 in FIG. 3) performed by the display processor 9, the conversion candidates are displayed based on the order set in step S306.

As described above, in one or more embodiments of the present invention, the phrase, which is fixed through the character input processing and input to the high-order application, is registered in the learning dictionary 11 while combined with the conversation subject date and time data at the time the phrase is fixed, and the candidate, which is registered in the learning dictionary 11 while combined with the conversation subject date and time data applied to the current conversation subject date and time data in the collocation predictive candidates and the conversion candidates, is preferentially displayed compared with other candidates. Therefore, in the case that the mail relating to the case that the mail was created in the past while the date and time was specified is created again, even if the date and time is expressed by the phrase different from that of the previous mail, or even if the character input is started in timing corresponding to the date and time of the case, the phrase learned with respect to the case can be displayed in the high order of the candidate display field 200a.

In the description of one or more embodiments of the present invention, the fixed phrase is registered in the learning dictionary 11 during the character input processing. Additionally, the phrase included in the mail received from the outside can also be registered in the learning dictionary 11. For example, in the conversation subject date and time estimation unit 7, after the date and time in which the incoming mail is transmitted is set to the initial value of the conversation subject date and time data, a morpheme analysis is performed to the document data of the incoming mail, and the same sequence as steps S102 to S107 in FIG. 4 is performed to each phrase extracted through the analytical processing. The learning processor 6 registers each phrase extracted from the incoming mail in the learning dictionary 11 while combining the phrase with the conversation subject date and time data set through the above processing. When the plural phrases each of which expresses the date and time exist while being not able to be unified, the conversation subject date and time data is set in each phrase, and which pieces of conversation subject date and time data each of remaining phrases is correlated with may be determined based on a modification relation among the phrases.

Because one or more embodiments of the present invention is aimed at the character input processing of the mobile device, the display order (priority) of the candidate suitable for the current conversation subject date and time data is enhanced for both the collocation predictive processing and the predictive conversion processing. Additionally, the technique can also be applied to the character input processing of the personal computer.

In the personal computer, because the character string including the plural words are probably fixed at once, for example, the character string is analyzed every time the character string is fixed, and the conversation subject date and time data can be set as the phrase expressing the date and time is extracted. When the character string including the plural words is fixed, each word included in the fixed character string may be registered in the learning dictionary while combined with the current conversation subject date and time data, or the whole fixed character string may be registered as data of one unit while combined with the conversation subject date and time data.

In the personal computer, because the candidate of the post-conversion character string is extracted as the conversion manipulation is performed after the input of the reading character string, the candidate combined with the conversation subject date and time data applied to the current conversation subject date and time data in the extracted candidates can preferentially be displayed compared with other candidates.

In the case that the whole of the fixed character string is registered in the learning dictionary, the learning dictionary is searched while the reading character string is input, the character string in which the conversation subject date and time data is applied to the current setting can be displayed as the candidate of the post-conversion character string in the character strings that match the reading character string on the left-hand side.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

### DESCRIPTION OF SYMBOLS

S: Character input system
1: Key manipulation receiving unit
2: Reading character string constructing unit
3: Predictive conversion processor
4: Fixing processor
5: Priority update unit
6: Learning processor
7: Conversation subject date and time estimation unit
8: Collocation predictive processor
9: Display processor
10: Conversion dictionary
11: Learning dictionary
12: Date and time corresponding table
200: Mail creating screen
200a: Candidate display field

1. A method for displaying a candidate in a character input, comprising:
storing a conversion dictionary and a learning dictionary in a storage section of a computer;
registering a plurality of pieces of dictionary data each of which includes a pre-conversion character string and a post-conversion character string in the conversion dictionary;
using the learning dictionary to register a phrase fixed as an input character string while the phrase is correlated with collocation relationship between phrases;
performing via character input processing including a first candidate extracting step, a second candidate extracting step, and a candidate fixing step;
searching the conversion dictionary using the pre-conversion character string in response to an input of the pre-conversion character string to extract and display a candidate of the post-conversion character string in the first candidate extracting step;
extracting a phrase that collocates with the phrase indicated by the fixed character string from the learning dictionary and displayed as the input character string is fixed in the second candidate extracting step;
fixing the phrase of the selected candidate as one of the candidates displayed in one of the first and second candidate extracting steps is selected in the candidate fixing step;
performing via the computer a date and time estimation step and a registration step;
estimating a date and time according to a fixed situation of a phrase expressing the date and time and date and time data indicating an estimation result being set in the date and time estimation step;
registering the phrase fixed in the candidate fixing step in the learning dictionary while correlated with the date and time data in the registration step; and
preferentially displaying via the computer a candidate that is registered in the learning dictionary while correlated with date and time data, which is applied to date and time data at a time a preceding phrase is fixed, in candidates extracted from the learning dictionary in the second candidate extracting step, compared with other candidates.

2. The method for displaying the candidate in the character input according to claim 1,
wherein the date and time estimation step includes:
a step of initially setting the date and time data to data indicating a current date and time in response to starting of the character input processing; and
a step of updating the date and time data based on a concept of the date and time expressed by the fixed phrase as the phrase expressing the date and time is fixed.

3. The method for displaying the candidate in the character input according to claim 1,
wherein when the phrase expressing the date and time is fixed in the candidate fixing step, in the second candidate extracting step, a first search and a second search are performed using the date and time data that is set in the date and time estimation step according to the fixed phrase, the first search specifying a phrase, which corresponds to date and time data applied to the date and time data and expresses the date and time, the second search extracting a phrase that is registered in the learning dictionary while collocating with the phrase specified by the first search, and the phrase extracted through the second search is included in the preferentially-displayed candidate.

4. The method for displaying the candidate in the character input according to claim 1,
wherein when document data received from an outside is analyzed to extract a phrase expressing a date and time, date and time data suitable for a concept of the phrase is set, and the set date and time data is registered in the learning dictionary while correlated with the phrase expressing the date and time and each phrase collocating with the phrase expressing the date and time.

5. The method for displaying the candidate in the character input according to claim 1,
wherein in the first candidate extracting step, the candidate that is registered in the learning dictionary while correlated with the date and time data applied to the date and time data set in the date and time estimation step is specified from the candidates, which are extracted from the conversion dictionary using the input pre-conversion character string, and the specified candidate is preferentially displayed compared with other candidates.

6. A character inputting program stored on a non-transitory computer readable medium that causes a computer to act as a character input apparatus, the character input apparatus comprising:
a storage section in which a conversion dictionary and a learning dictionary are stored, wherein
a plurality of pieces of dictionary data each of which includes a pre-conversion character string and a post-conversion character string are registered in the conversion dictionary, and
the learning dictionary is used to register a phrase fixed as an input character string while the phrase is correlated with collocation relationship between phrases;
a first candidate extracting section that searches the conversion dictionary using the pre-conversion character string in response to an input of the pre-conversion character string to extract and displays a candidate of the post-conversion character string;
a second candidate extracting section that extracts and displays a phrase that collocates with the phrase indicated by the fixed character string from the learning dictionary as the input character string is fixed;
a candidate fixing section that fixes the phrase of the selected candidate as one of the candidates displayed by the first and second candidate extracting section is selected; and
a registration processing section that registers the phrase fixed by the candidate fixing section in the learning dictionary,
wherein the program further comprises a program that causes the computer to act as date and time estimation section that estimates a date and time according to a fixed situation of a phrase expressing the date and time, and sets date and time data indicating an estimation result,
wherein the registration processing section registers the phrase fixed in the candidate fixing step in the learning dictionary while correlating the phrase with the date and time data, and
wherein the second candidate extracting section preferentially displays a candidate that is registered in the learning dictionary while correlated with date and time data, which is applied to date and time data at a time a preceding phrase is fixed, in candidates extracted from the learning dictionary, compared with other candidates.

7. The character inputting program according to claim 6,
wherein the date and time estimation section initially sets the date and time data to data indicating a current date and time in response to start-up of the document input device, and then as a phrase expressing a date and time is fixed by the candidate fixing section, the date and time estimation section updates the date and time data based on a concept of the date and time expressed by the fixed phrase.

8. The character inputting program according to claim 7,
wherein when processing is performed as the phrase expressing the date and time is fixed, the second candidate extracting section performs is a first search and a second search using the date and time data that is set according to the fixed phrase by the date and time estimation section, the first search specifying a phrase, which corresponds to date and time data applied to the date and time data and expresses the date and time, the second search extracting a phrase that is registered in the learning dictionary while collocating with the phrase specified by the first search, and the second candidate extracting section includes the phrase extracted through the second search in the preferentially-displayed phrase.

9. The character inputting program according to claim 6,
wherein the first candidate extracting section specifies the candidate, which is registered in the learning dictionary while correlated with the date and time dataset by the date and time estimation section, from the candidates, which are extracted from the conversion dictionary using the input pre-conversion character string, and the first candidate extracting section preferentially displays the specified candidate compared with other candidates.

10. A character input apparatus, comprising:
a storage section in which a conversion dictionary and a learning dictionary are stored, wherein
a plurality of pieces of dictionary data each of which includes a pre-conversion character string and a post-conversion character string are registered in the conversion dictionary, and
the learning dictionary is used to register a phrase fixed as an input character string while the phrase is correlated with collocation relationship between phrases;
a first candidate extracting section that searches the conversion dictionary using the pre-conversion character string in response to an input of the pre-conversion character string to extract and display a candidate of the post-conversion character string;
a second candidate extracting section that extracts and displays a phrase that collocates with the phrase indicated by the fixed character string from the learning dictionary as the input character string is fixed;
a candidate fixing section that fixes the phrase of the selected candidate as one of the candidates displayed by the first and second candidate extracting section is selected;
a registration processing section that registers the phrase fixed by the candidate fixing section in the learning dictionary; and
a date and time estimation section that estimates a date and time according to a fixed situation of a phrase expressing the date and time, and sets date and time data indicating an estimation result,
wherein the registration processing section registers the phrase fixed in the candidate fixing step in the learning dictionary while correlating the phrase with the date and time data, and the second candidate extracting section preferentially displays a candidate that is registered in the learning dictionary while correlated with date and time data, which is applied to date and time data at a time a preceding phrase is fixed, in candidates extracted from the learning dictionary, compared with other candidates.

11. The method for displaying the candidate in the character input according to claim 2,
wherein when the phrase expressing the date and time is fixed in the candidate fixing step, in the second candidate extracting step, a first search and a second search are performed using the date and time data that is set in the date and time estimation step according to the fixed phrase, the first search specifying a phrase, which corresponds to date and time data applied to the date and time data and expresses the date and time, the second search extracting a phrase that is registered in the learning dictionary while collocating with the phrase specified by the first search, and the phrase extracted through the second search is included in the preferentially-displayed candidate.

12. The method for displaying the candidate in the character input according to claim 2,
wherein when document data received from an outside is analyzed to extract a phrase expressing a date and time, date and time data suitable for a concept of the phrase is set, and the set date and time data is registered in the learning dictionary while correlated with the phrase expressing the date and time and each phrase collocating with the phrase expressing the date and time.

13. The method for displaying the candidate in the character input according to claim 3,
wherein when document data received from an outside is analyzed to extract a phrase expressing a date and time, date and time data suitable for a concept of the phrase is set, and the set date and time data is registered in the learning dictionary while correlated with the phrase expressing the date and time and each phrase collocating with the phrase expressing the date and time.

14. The method for displaying the candidate in the character input according to claim 2,
wherein in the first candidate extracting step, the candidate that is registered in the learning dictionary while correlated with the date and time data applied to the date and time data set in the date and time estimation step is specified from the candidates, which are extracted from the conversion dictionary using the input pre-conversion character string, and the specified candidate is preferentially displayed compared with other candidates.

15. The method for displaying the candidate in the character input according to claim 3,
wherein in the first candidate extracting step, the candidate that is registered in the learning dictionary while correlated with the date and time data applied to the date and time data set in the date and time estimation step is specified from the candidates, which are extracted from the conversion dictionary using the input pre-conversion character string, and the specified candidate is preferentially displayed compared with other candidates.

16. The method for displaying the candidate in the character input according to claim 4,
wherein in the first candidate extracting step, the candidate that is registered in the learning dictionary while correlated with the date and time data applied to the date and time data set in the date and time estimation step is specified from the candidates, which are extracted from the conversion dictionary using the input pre-conversion character string, and the specified candidate is preferentially displayed compared with other candidates.

17. The character inputting program according to claim 7,
wherein the first candidate extracting section specifies the candidate, which is registered in the learning dictionary while correlated with the date and time dataset by the date and time estimation section, from the candidates, which are extracted from the conversion dictionary using the input pre-conversion character string, and the first candidate extracting section preferentially displays the specified candidate compared with other candidates.

18. The character inputting program according to claim 8,
wherein the first candidate extracting section specifies the candidate, which is registered in the learning dictionary while correlated with the date and time dataset by the date and time estimation section, from the candidates, which are extracted from the conversion dictionary using the input pre-conversion character string, and the first candidate extracting section preferentially displays the specified candidate compared with other candidates.
